(19) United States
(12) Patent Application Publication
(10) Pub. No.: US 2025/0189079 A1
(43) Pub. Date: Jun. 12, 2025

(54) MOISTURE EVAPORATION SYSTEM FOR PORTABLE GAS SOURCE

(71) Applicant: HILL-ROM SERVICES PTE.LTD., SINGAPORE (SG)

(72) Inventor: Loren Thompson, Auburn Hills, MI (US)

(21) Appl. No.: 18/968,921

(22) Filed: Dec. 4, 2024

Related U.S. Application Data
(60) Provisional application No. 63/607,345, filed on Dec. 7, 2023.

(51) Int. Cl. F17C 9/04

(52) U.S. Cl. CPC F17C 9/04; F17C 2205/0332; F17C 2223/0161; F17C 2227/0164; F17C 2227/0185; F17C 2227/0339; F17C 2227/0348; F17C 2265/034; F17C 2265/037

(57) ABSTRACT

A portable gas source (PGS) comprising a compressor, a cooling fan, and at least one storage tank in fluid communication with the compressor for storing compressed gas. The PGS further comprises at least one valve which is fluidly connected to the storage tank and is selectively movable between a closed and open positions. An evaporation pad assembly of the PGS is placeable into fluid communication with the storage tank when the valve is actuated to the open position. The evaporation pad assembly comprise a feed ring defining an outlet port which is fluidly connected to the valve such than an open path of fluid communication between the outlet port and the storage tank is established when the valve is actuated to the open position. The evaporation pad assembly also includes at least one evaporation pad which is positioned relative to the feed ring to operatively absorb fluid flowing from the outlet port. In the PGS, the compressor, the cooling fan, and the evaporation pad assembly are positioned relative to each other such that air circulated by the cooling fan passes over both the compressor and the evaporation pad assembly to cool the compressor and simultaneously facilitate moisture evaporation from the evaporation pad.

### CROSS-REFERENCE TO RELATED APPLICATIONS

The present application claims priority to U.S. Provisional Application Ser. No. 63/607,345 filed Dec. 7, 2023, the disclosure of which is incorporated herein by reference.

### STATEMENT RE: FEDERALLY SPONSORED RESEARCH/DEVELOPMENT

Not Applicable

### BACKGROUND

### 1. Technical Field of the Invention

The present disclosure relates generally to a portable gas source (PGS) and, more particularly, to a PGS which includes, among other things, an integrated oxygen concentrator, a compressor, and a moisture evaporation system adapted to effectively remove condensate or “rainout” which may accumulate in either or both of two storage tanks of the PGS.

### 2. Description of the Related Art

A wide range of clinical conditions may require some form of ventilation therapy, whereby the patient's work of breathing is assisted by the flow of pressurized gas from a ventilator to the patient's airway. These conditions may include hypoxemia, various forms of respiratory insufficiency, and airway disorders. There are also non-respiratory and non-airway diseases that require ventilation therapy, such as congestive heart failure and neuromuscular diseases.

To improve the quality of life of many patients who require long-term ventilation therapy, ventilation systems have been developed which are miniaturized and portable. Some of these systems, for example, the Life2000® system by Breathe Technologies, Inc., are so lightweight and compact that in their extended range or stand-alone configurations, they are wearable by the patient. These systems make use of a source of pressurized ventilation gas to operate. In the stationary or extended-range configuration, the source of pressurized gas may be a stationary compressor unit, which may be kept in a patient's home. In the stand-alone configuration, which may be generally used when the patient is outside the home, the portable, wearable ventilator generally receives its ventilation gas from a pressurized gas cylinder or a portable compressor.

Many of the above clinical conditions and other clinical conditions may also require or benefit from supplemental oxygen therapy, whereby the gas introduced to the patient's airway is augmented by the presence of additional oxygen such that the patient inspires gas having oxygen levels above atmospheric concentration (20.9% at 0% humidity). Supplemental oxygen therapy involves the patient receiving supplemental oxygen gas from an oxygen gas source, which is typically a compressed or cryogenic oxygen cylinder, or an oxygen gas generator. For many years, patients who wished to be mobile relied on oxygen cylinders. However, in recent years, miniaturization and improvements in battery technology has resulted in the development of portable oxygen concentrators.

Portable oxygen concentrators typically operate by pressure swing adsorption (PSA), in which ambient air is pressurized by a compressor and passed through an adsorbent sieve bed. The sieve bed is typically formed of a zeolite which preferentially adsorbs nitrogen when at high pressure while oxygen passes through. Once the sieve bed reaches its capacity to adsorb nitrogen, the pressure can be reduced. This reduction in pressure causes the adsorbed nitrogen to be desorbed so it can be purged, leaving a regenerated sieve bed that is again ready to adsorb nitrogen. With repeated cycles of this operation, an enriched oxygen gas may be generated. Typically, portable oxygen concentrators have at least two sieve beds so that one may operate while the other is being purged of the nitrogen and vented. Typical portable oxygen concentrators today output an enriched oxygen gas with a purity of around 87-96% oxygen. Among existing oxygen concentrators today which may be considered portable (especially by an individual suffering from a respiratory condition), there are generally two types available. The first type, which is larger and heavier, is usually capable of continuous flow delivery. Models of this type typically weigh between 5-10 kg, have maximum flow rates of around 5-6 liters per minute or less, and are generally configured with wheels and a handle, often mimicking the appearance of a suitcase. The second type are lighter units more suitable for being carried or worn in a satchel, handbag, or a backpack. Models of this type typically weigh less than 2.5 kg and are usually limited to pulsed delivery modes with maximum flow rates of around 2 liters per minute or less.

Portable oxygen concentrators have a substantial cost and convenience advantage over pressurized oxygen cylinders, due to the pressurized oxygen cylinders requiring ongoing refilling or replacement. Additionally, portable oxygen concentrators are considered to be significantly safer than pressurized oxygen cylinders. This safety consideration can have a substantial impact on a patient's quality of life, because many portable oxygen concentrators have been approved by the FAA for use by travelers on commercial airlines, whereas oxygen cylinders are universally banned on commercial flights. Consequently, patients with pressurized oxygen cylinders must make expensive and time-consuming preparations with an airline ahead of time or forego airline travel entirely.

For patients with conditions where assistance with the work of breathing is not required, supplemental oxygen therapy alone, without ventilation therapy, may be sufficient. However, for many patients, combined ventilation therapy and supplemental oxygen therapy may be a more optimal treatment. In healthy patients, sufficient ventilation to perform the work of breathing may typically require minute ventilation rates of between 5 and 8 L/min while stationary, which may double during light exercise, and which may exceed 40 L/min during heavy exercise. Patients suffering from respiratory conditions may require substantially higher rates, and substantially higher instantaneous rates. This is especially true when these patients are outside the home and require portability, as at these times such patients are often also involved in light exercise.

It may thus be seen that patients who would prefer to receive this combined mode of treatment are substantially limited, since in many cases existing portable oxygen concentrators do not output gas at pressures and/or volumes high enough to be used with a wearable, portable ventilator without the presence of an additional source of compressed gas. While existing systems and methods that seek to provide a combined supplemental oxygen/ventilation system have been developed in the prior art, these existing systems suffer from various deficiencies which Applicant has addressed in the system described in its U.S. Pat. No. 11,607,519 entitled O2 CONCENTRATOR WITH SIEVE BED BYPASS AND CONTROL METHOD THEREOF, the disclosure of which is incorporated herein by reference.

Within the system described in U.S. Pat. No. 11,607,519, the oxygen concentrator and compressor elements (among others) are housed in a unit which may be broadly characterized as a PGS. During the normal operation of the PGS, compressed gas which includes oxygen produced by the oxygen concentrator is stored in one or more storage canisters or tanks. The storage tanks are located at the bottom of the PGS, and are the coldest part of the functioning system, thus causing any excess water vapor in the compressed gas stored therein to condense within the storage tanks (commonly referred to as a “rainout” effect). As a result, the storage tanks accumulate condensate (i.e., water) in the bottom thereof, which must be periodically drained therefrom. Once drained from the storage tanks, this water must be effectively removed from within the PGS, preferably by outfitting the PGS with some moisture evaporation or dissipation system. However, complicating the ability to effectively accomplish this moisture evaporation function is the limited space availability within the housing of the PGS to accommodate the corresponding system. The present disclosure provides a unique and effective moisture evaporation system solution for the PGS, such system including the achievement of spatial economies by, among other things, having a compressor cooling fan of the PGS provide dual use functionality, one of which is moisture evaporation. These and other attributes of the present disclosure will be described in more detail below.

### BRIEF SUMMARY

The present disclosure is drawn to moisture evaporation system of the PGS which is designed to remove excess water that accumulates in the storage tanks thereof. The storage tanks are located at the bottom of the PGS. As indicated above, the storage tanks typically comprise the coldest part of the system, thus causing any excess water vapor in the compressed gas stored therein to rain out and accumulate as water in the bottom thereof. Each of the storage tanks has a bleed on the bottom thereof, with the gas pressure therein being operative to drive the water in the storage tank up a corresponding transfer tube that terminates in an absorbent evaporation pad that is located proximate the compressor of the PGS. Each bleed is activated by a solenoid valve that opens periodically to let the water bleed from a corresponding storage tank into the evaporation pad. A cooling fan located directly above the compressor takes in ambient air and drives the heat from the compressor across the evaporation pad to dry it out. The air is exhausted outside of the PGS.

In greater detail, the PGS comprises a housing having both a compressor and a cooling fan disposed therein. At least one storage tank is also disposed within the housing and in fluid communication with the compressor for storing compressed gas. Also disposed within the housing is at least one valve which is fluidly connected to the storage tank, the valve being selectively movable between a closed position and an open position.

An evaporation pad assembly is also disposed within the housing and placeable into fluid communication with the storage tank when the valve is actuated to the open position. The evaporation pad assembly comprises a feed ring defining an outlet port which is fluidly connected to the valve such than an open path of fluid communication between the outlet port and the storage tank is established when the valve is actuated to the open position. Also included in the evaporation pad assembly is at least one evaporation pad which is at least partially surrounded by the feed ring and positioned relative thereto to operatively absorb fluid flowing from the outlet port. The compressor, the cooling fan, and the evaporation pad assembly are positioned within the housing relative to each other such that air circulated by the cooling fan passes over both the compressor and the evaporation pad assembly to cool the compressor and simultaneously facilitate moisture evaporation from the evaporation pad.

In the PGS, the at least one storage tank may comprise a first storage and a second storage tank which are fluidly connected to each other. Similarly, the at least one valve may comprise a first valve fluidly connected to the first storage tank and a second valve fluidly connected to the second storage tank. The outlet port of the feed ring may be fluidly connected to each of the first and second valves such that the first and second valves are operative to selectively establish an open path of fluid communication between the outlet port and respective ones of the first and second storage tanks when actuated to the open position.

The first and second storage tanks of the PGS may be fluidly coupled to a common manifold which is configured to facilitate the fluid connection of the first and second storage tanks to each other and to respective ones of the first and second valves. A first transfer tube may be fluidly connected to and extended between the first valve and the manifold to partially define the open path of fluid communication between the outlet port and the first storage tank when the first valve is in the open position. Similarly, a second transfer tube may be fluidly connected to and extended between the second valve and the manifold to partially define the open path of fluid communication between the outlet port and the second storage tank when the second valve is in the open position.

The first and second storage tanks may be fluidly coupled to the manifold in side-by-side relation to each other, with the compressor and the evaporation pad assembly being positioned between the first and second storage tanks and the cooling fan. In addition, the compressor and the evaporation pad assembly may be disposed in side-by-side relation to each other.

The evaporation pad assembly may further comprise at least one grate portion, with the at least one evaporation pad extending at least partially along and in contact with the grate portion. The evaporation pad may have a circular, disc-like configuration, with the grate portion also having a circular configuration, and the evaporation pad and the grate portion being coaxially aligned with each other. The cooling fan may be positioned relative to evaporation pad assembly such that air circulated by the cooling fan passes predominantly diametrically over a surface of the evaporation pad which faces the grate portion.

The at least one evaporation pad may comprise first and second evaporation pads which are each at least partially surrounded by the feed ring and are disposed in spaced relation to each other such that a gap is defined therebetween. In addition, the first and second evaporation pads may be positioned relative to the feed ring such that the output port fluidly communicates with the gap in manner wherein fluid flowing from the outlet port may be absorbed by one or both of the first and second evaporation pads.

The evaporation pad assembly may further comprise first and second grate portions disposed in opposed, spaced relation to each other. The first and second evaporation pads and the feed ring may be operatively captured between the first and second grate portions such that the first and second evaporation pads extend at least partially along and in contact with respective ones of the first and second grate portions. The first and second evaporation pads may each have a circular, disc-like configuration and may be coaxially aligned with each other between the first and second grate portions. The cooling fan may be positioned relative to evaporation pad assembly such that air circulated by the cooling fan passes predominantly diametrically over respective surfaces of each of the first and second evaporation pads which do not face the gap therebetween.

Further in accordance with the present disclosure, there is provided a method for removing condensate from within at least one storage tank of a PGS also having a compressor and a cooling fan. The method may comprise providing at least one valve which is fluidly connected to the storage tank and selectively movable between a closed position and an open position. The method may also comprise providing a feed ring which defines an outlet port fluidly connected to the valve such than an open path of fluid communication between the outlet port and the storage tank is established when the valve is actuated to the open position, and further providing at least one evaporation pad which is cooperatively engaged to the feed ring to operatively absorb fluid flowing from the outlet port.

In the present method, the valve may be actuated to the open position to cause compressed gas in the storage tank to force condensate therein though the open path of fluid communication into the evaporation pad. The cooling fan may also be activated to circulate air over both the compressor and the evaporation pad to cool the compressor and simultaneously facilitate moisture evaporation from the evaporation pad.

The method may comprise providing a first storage and a second storage tank which are fluidly connected to each other, and further providing a first valve which is fluidly connected to the first storage tank and a second valve which is fluidly connected to the second storage tank. The outlet port may be fluidly connected to each of the first and second valves such that the first and second valves are operative to selectively establish an open path of fluid communication between the outlet port and respective ones of the first and second storage tanks when actuated to the open position. In addition, the first and second valves may be alternately actuated to the open position to cause compressed gas in respective ones of the first and second storage tanks to force condensate therein though the open path of fluid communication corresponding thereto into the evaporation pad.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side view of an exemplary PGS into which the moisture evaporation system according to an embodiment of the present disclosure is integrated;

FIG. 2 is a top perspective view of the exemplary PGS with the exterior housing removed for purposes of exposing various internal features of the PGS, including a portion of the present moisture evaporation system;

FIG. 3 is side elevational similar to FIG. 2, but with several additional internal features of the PGS at least partially removed for purposes of exposing a portion of the present moisture evaporation system;

FIG. 4 is an enlargement of a portion of FIG. 3, depicting the solenoid valves and part of the evaporation pad assembly of the present moisture evaporation system;

FIG. 5 is a top perspective view of the storage tanks of the PGS, further depicting the transfer or drainage tubes of the present moisture evaporation system;

FIG. 6 is a top, perspective view of the exemplary PGS with the exterior housing removed, depicting of compressor cooling fan which has dual use functionality by further assisting in the operation of the present moisture evaporation system;

FIG. 7 is a top perspective view of the evaporation pad assembly shown in FIGS. 2-4;

FIG. 8 is an exploded view of the evaporation pad assembly shown in FIG. 7;

FIG. 9 is a front view of the evaporation pad assembly shown in FIG. 7 with an outer grate removed for purposes of exposing an outer evaporation pad;

FIG. 10 is a perspective view of the evaporation pad assembly shown in FIG. 7 with the outer grate and both of outer and inner evaporation pads removed for purposes of exposing a feed ring;

FIG. 11 is a top perspective view of the compressor and underlying support stand as integrated into the exemplary PGS; and

FIG. 12 is a side view depicting the air flow pattern in the PGS from the compressor cooling fan over the evaporation pad assembly.

### DETAILED DESCRIPTION

The present disclosure encompasses a portable gas source (PGS) 10, a preferred iteration of which is an oxygen concentrator which is operative to deliver a high oxygen content gas to a patient via a ventilator. In this regard, and with reference to the drawings, the PGS 10 includes, among other things, a compressor 12, a compressor cooling fan 14, a pair of oxygen producing sieve beds 16, 18, and at least one, but preferably two, storage tanks, i.e., a first storage tank 20 and a second storage tank 22, which store compressed gas including oxygen produced by the sieve beds 16, 18. In addition, the PGS 10 is outfitted with a moisture evaporation system which effectively removes or dissipates, via an evaporative process, the condensate (i.e., water) which normally accumulates in the bottom of each of the first and second storage tanks 20, 22 as a result of a rainout effect. The detailed description set forth below in connection with the appended drawings is intended as a description of a currently contemplated embodiment of the PGS 10, with emphasis on its moisture evaporation system, and is not intended to represent the only form in which the disclosed invention may be developed or utilized. The description sets forth the functions and features in connection with the illustrated embodiment. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

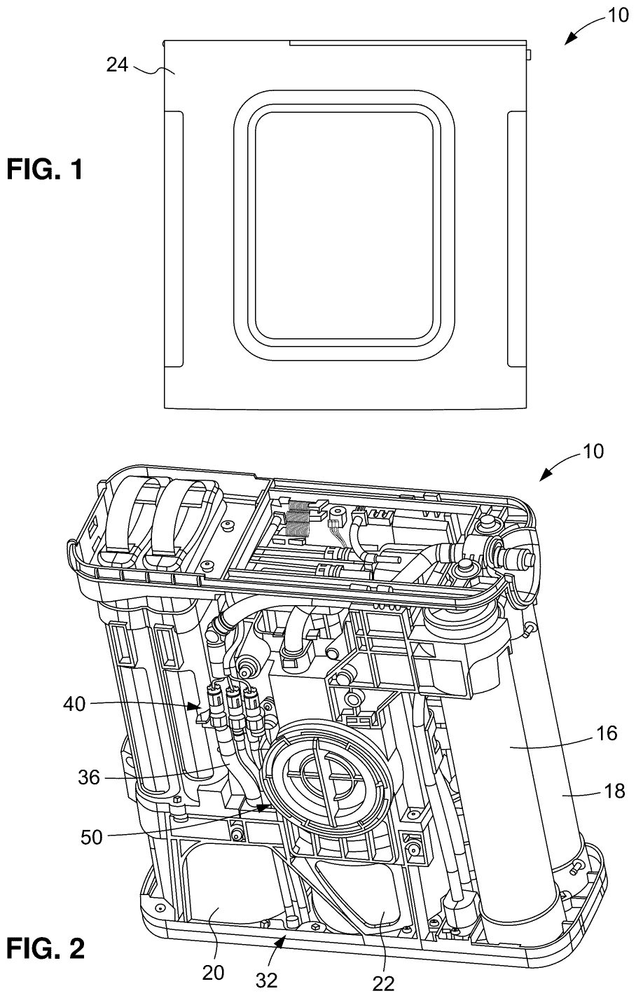

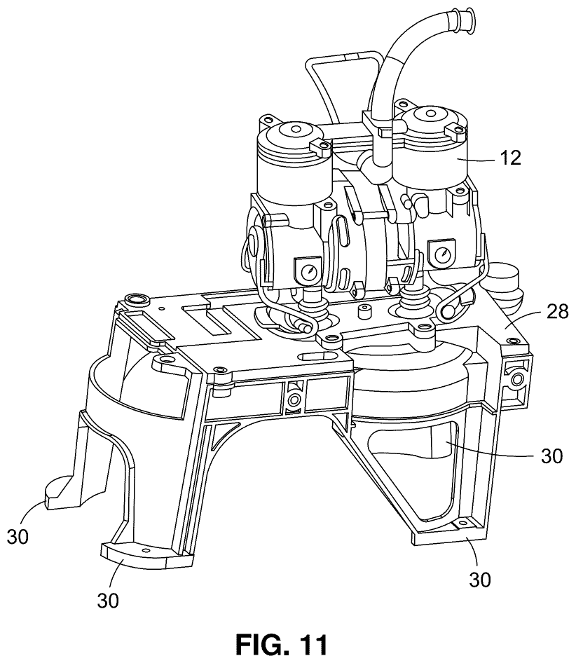

The PGS 10 shown in FIG. 1 is designed to be operative to deliver a high oxygen content gas produced by an internal oxygen concentrator working in concert with the internal compressor 12 (shown in FIG. 11). The PGS 10 includes an outer housing 24 which effectively covers or shields the internal components thereof, including those identified above. As previously indicated, several structural and functional features of the PGS 10 are described with particularity in U.S. Pat. No. 11,607,519 entitled O2 CONCENTRATOR WITH SIEVE BED BYPASS AND CONTROL METHOD THEREOF which is incorporated herein by reference.

In the description of the PGS 10 which follows, emphasis will be placed on the structural and functional attributes of the moisture evaporation system thereof which comprises several of those above-referenced internal components disposed within the housing 24. Along these lines, as will be described in more detail below, considering the over-arching desirability to construct the PGS 10 to be as small and lightweight as possible, the moisture evaporation system is uniquely configured to efficiently function within the internal spatial constraints of the housing 24. This achievement of spatial economies entails, among other things, having certain internal components of the PGS 10, namely the cooling fan 14 for the compressor 12, provide dual use functionality.

In general, in order to produce the high oxygen content gas from ambient air, the compressor 12 of the PGS 10 pumps ambient air through the sieve beds 16, 18 which remove nitrogen from the pressurized air. The resulting gas having high oxygen concentration flows into the first and second storage tanks 20, 22 for eventual delivery to ventilator (not shown). The sieve beds 16, 18 have opposed operation cycles, sieve bed 16 filling the first and second storage tanks 20, 22 with high oxygen content gas at the same time that sieve bed 18 is exhausting nitrogen to ambient and vice versa.

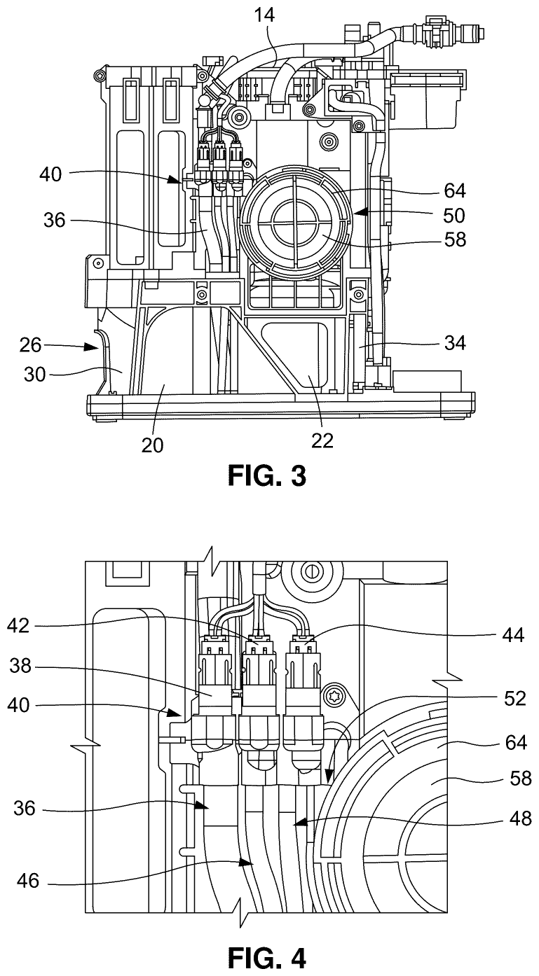

FIG. 2 depicts the PGS 10 with the exterior housing 24 removed for purposes of exposing various internal features of the PGS 10. In FIG. 3, several internal features of the PGS 10 unrelated to the moisture evaporation system serving as the focal point of the subject disclosure are removed in comparison to FIG. 2. As seen in FIG. 11, the compressor 12 is positioned upon the stand 26 which effectively elevates the compressor 12 to a location within the housing 24 which is well above any support surface upon which the PGS 10 may be rested when viewed for the perspective shown in FIG. 1. In more general terms, which are sufficient based on the intended emphasis of the present disclosure, the stand 26 comprises a primary support surface 28 which is elevated by four legs 30. These legs 30 are not identically configured, but rather are provided in one pair which are each of a first shape, and a second pair which are each of a second shape different from the first. The primary support surface 28 and the legs 30 collectively, partially define a void or open space which accommodates select internal components of the PGS 10, including the side-by-side first and second storage tanks 20, 22. The stand 26 functions as a support modality which effectively positions the compressor 12 in a location within the interior of the housing 24 as allows to be operatively interfaced to other internal components of the PGS 10 in a manner minimizing spatial requirements, and thus optimizing spatial efficiency. Along these lines, as seen in and viewed from the perspective of FIG. 3, the compressor 12 and storage tanks 20, 22 are located at respective ones of the opposite sides of the primary support surface 28, i.e., the compressor 12 above it and the storage tanks 20, 22 below it.

The compressor 12 integrated into the PGS 10 is of the double acting variety. In other words, in general terms, it includes a pair unidirectional inlet check valves proximate respective ones of the opposed ends of a cylinder bore, and a pair of unidirectional outlet check valves which are likewise proximate respective ones of the opposed ends of the cylinder bore. The compressor 12 also includes a reciprocating piston which is disposed within the cylinder bore and works in both directions, i.e., the intake stroke on one end becomes the compression stroke on the other, and vice versa. These inlet and outlet check valves are integrated into respective air inlets and air outlets which are segregated into two pairs of one inlet and outlet each. These pairs fluidly communicate with the interior of the cylinder bore at respective, opposite sides of the piston. The air outlets also fluidly communicate a common air outlet of the compressor 12. During operation of the compressor 12, any intake stroke of the piston draws air through one of the air inlets (including a corresponding one of the integrated inlet check valves) and into a portion of the cylinder bore. Any compression stroke of the piston forces air from a portion of the cylinder bore through one of the air outlets (including a corresponding one of the integrated outlet check valves) and thereafter through the common air outlet.

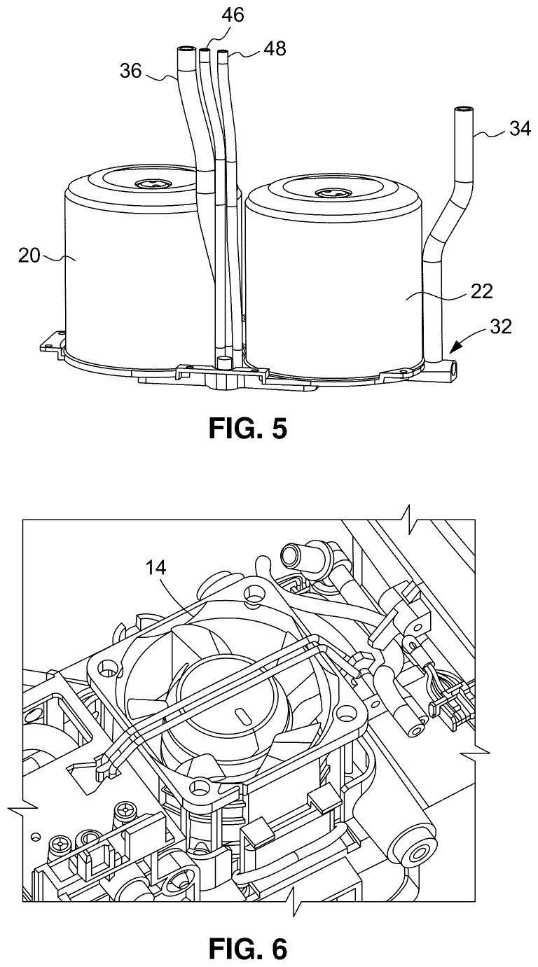

As indicated above, the first and second storage tanks 20, 22 are preferably arranged in side-by-side relation to each other within the void or open space defined by the stand 26 underneath its primary support surface 28 and within its legs 30. As best seen in FIG. 5, in the PGS 10, the first and second storage tanks 20, 22 are fluidly coupled to a common manifold 32 which is configured to facilitate the fluid connection of the first and second storage tanks 20, 22 to each other. In greater detail, the manifold 32 is configured to define flow conduits as allows it to place the storage tanks 20, 22 into fluid communication with each other, in addition to one end of an elongate inlet tube 34. The inlet tube 34 transfers high oxygen content gas produced by the compressor 12 working in concert with the sieve beds 16, 18 into each of the storage tanks 20, 22 via the manifold 32. The flow conduits of the manifold 32 further place the storage tanks 20, 22 into fluid communication with one end of an elongate discharge tube 36. As seen in FIG. 4, the opposite end of the discharge tube 36 is fluidly connected to a discharge solenoid valve 38 included in a valve manifold 40 of the PGS 10. The actuation of the discharge solenoid valve 38 to an open position allows for the sampling of the compressed gas that is flowing from within the storage tanks 20, 22 to a ventilator (not shown). In addition to the discharge solenoid valve 38, the valve manifold 40 includes a first transfer solenoid valve 42 and a second transfer solenoid valve 44. The solenoid valves 38, 42, 44 are placed in side-by-side relation to each other within the valve manifold 40.

The bottom of each of the storage tanks 20, 22 of the PGS 10 is outfitted with a corresponding bleed assembly. As previously explained, as the storage tanks 20, 22 typically comprise the coldest part of the system, any excess water vapor in the compressed gas stored therein will typically rain out and accumulate as water in the bottom thereof. Each bleed assembly is configured to effectively channel or wick any accumulated water in the bottom of the corresponding one of the storage tanks 20, 22 to a prescribed flow conduit of the manifold 32. The flow conduit of the manifold 32 corresponding to the bleed assembly of the first storage tank 20 is fluidly connected to one end of elongate first drainage or transfer tube 46, the opposite end of which is fluidly connected to the first transfer solenoid valve 42 of the valve manifold 40. Similarly, the flow conduit of the manifold 32 corresponding to the bleed assembly of the second storage tank 22 is fluidly connected to one end of elongate second drainage or transfer tube 48, the opposite end of which is fluidly connected to the second transfer solenoid valve 44 of the valve manifold 40.

In PGS 10, each bleed assembly is effectively activated by the periodic actuation of the corresponding one of the first and second transfer solenoid valves 42, 44 to an open position. In greater detail, the actuation of the first transfer solenoid valve 42 to the open position allows the pressure with the first storage tank 20 to drive the accumulated water therein through the corresponding bleed assembly and first transfer tube 46. That water is then channeled from the first transfer tube 46, through the valve manifold 40, and into an evaporation pad assembly 50 which will be described in more detail below. In the same way, the actuation of the second transfer solenoid valve 44 to the open position allows the pressure with the second storage tank 22 to drive the accumulated water therein through the corresponding bleed assembly and second transfer tube 48. That water is then channeled from the second transfer tube 48, through the valve manifold 40, and into the evaporation pad assembly 50.

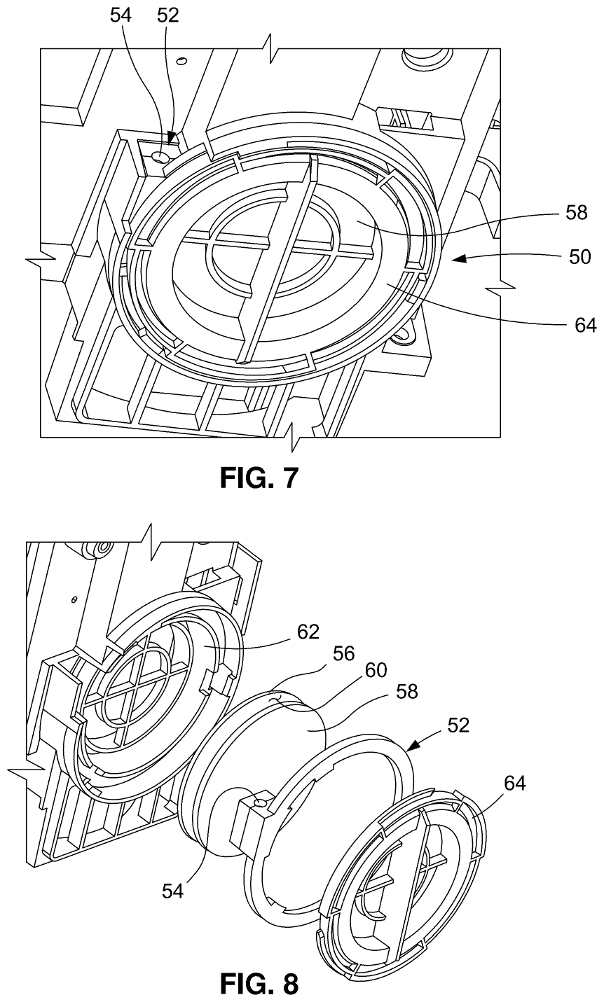

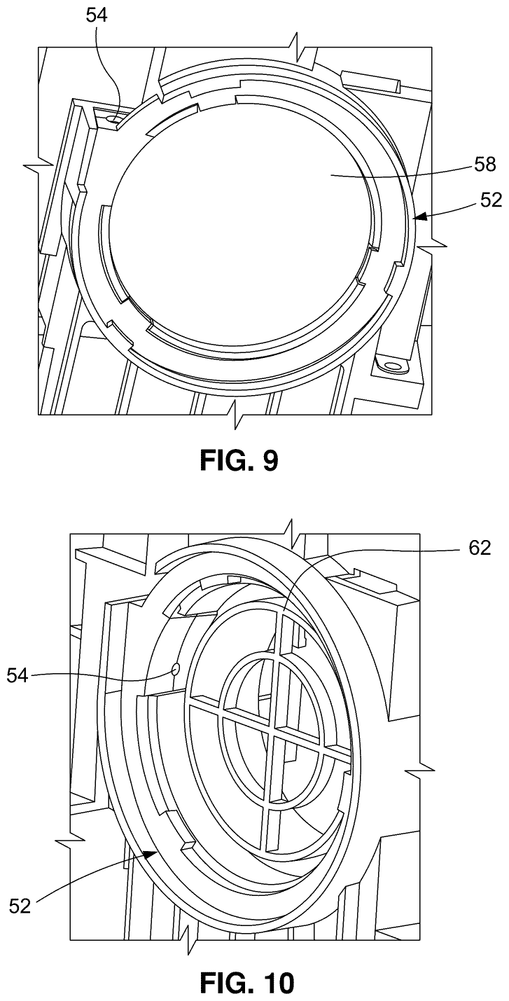

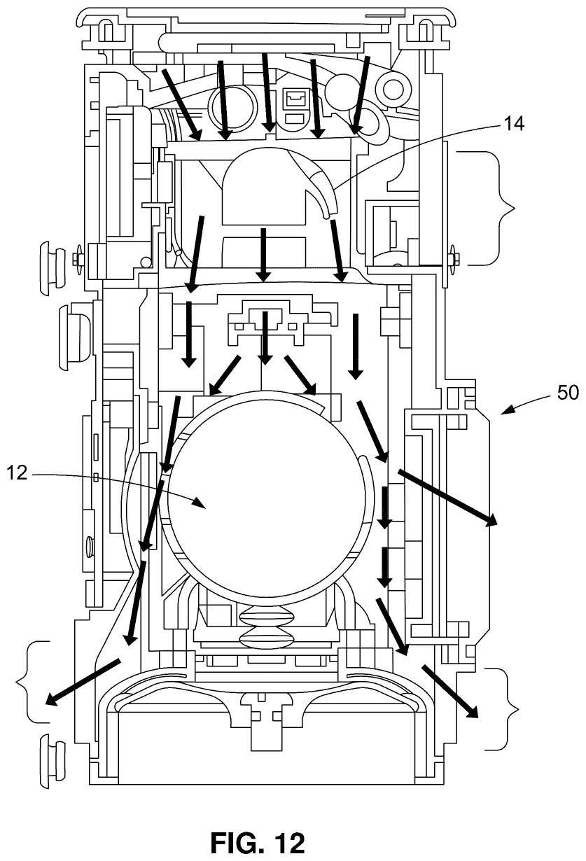

Referring now to FIGS. 2-3 and 7-10, the evaporation pad assembly 50, which is also disposed within the housing 24 and located in side-by-side relation to the compressor 12 (as seen in FIG. 12), comprises a feed ring 52 as one of its primary structural features. The feed ring 52 defines an outlet port 54 which is fluidly connected to the valve manifold 40 such that an open path of fluid communication between the outlet port 54 and the first storage tank 20 is established when the first transfer solenoid valve 42 is actuated to the open position, and a separate open path of fluid communication between the outlet port 54 and the second storage tank 22 is established when the second transfer solenoid valve 44 is actuated to the open position. The evaporation pad assembly 50 further comprises a first (inner) evaporation pad 56 and a second (outer) evaporation pads 58 which are each at least partially surrounded by the feed ring 52 and are disposed in spaced relation to each other such that a gap 60 is defined therebetween. In this regard, the first and second evaporation pads 56, 58 are positioned relative to the feed ring 52 such that the output port 54 fluidly communicates with the gap 60 in manner wherein fluid (water) flowing from the outlet port 54 may be absorbed by one or both of the first and second evaporation pads 56, 58. The first and second evaporation pads 56, 58 are identically configured, and each have a circular, disc-like configuration, while being fabricated from a material having absorbent properties.

The evaporation pad assembly 50 further comprises a generally circular first (inner) grate portion 62 and a generally circular second (outer) grate portion 64 disposed in opposed, spaced relation to each other. The first and second evaporation pads 56, 58 and the feed ring 52 are operatively captured between the first and second grate portions 62, 64 such that the first evaporation pad 56 extends at least partially along and in contact with the first grate portion 62, and the second evaporation pad 58 extends at least partially along and in contact with the second grate portion 64, such that the first and second evaporation pads 56, 58 are coaxially aligned with each other between the first and second grate portions 62, 64.

Referring now to FIGS. 3, 6 and 12, the compressor 12, the cooling fan 14, and the evaporation pad assembly 50 are positioned within the housing 24 relative to each other such that air circulated by the cooling fan 14 passes over both the compressor 12 and the evaporation pad assembly 50 to cool the compressor 12 and simultaneously facilitate moisture evaporation from the first and second evaporation pads 56, 58. As shown by the exemplary air flow pattern depicted in FIG. 12, the cooling fan 14 is positioned relative to evaporation pad assembly 50 such that air circulated by the cooling fan 14 passes predominantly diametrically over that surface of the first evaporation pad 56 which faces/abuts the first grate portion 62. However, at least a portion of that circulating air also passes through the first and second grate portions 62, 64, and hence both of the first and second evaporation pads 56, 58 positioned therebetween. Also, some of the air circulated by the cooling fan 14 may pass diametrically over that surface of the second evaporation pad 58 which faces/abuts the second grate portion 64. Air exiting the second grate portion 64 is exhausted from the PGS 10. Enhancing the ability of the circulating air to facilitate the evaporation of moisture absorbed into the first and second evaporation pads 56, 58 is the heating of that air which occurs as a result of it passing over the compressor before it reaches the evaporation pad assembly 50.

Thus, in the PGS 10, the cooling fan 14 provides dual-purpose functionality, i.e., the ability to provide effective cooling to the compressor 12 during its operation, while simultaneously being used to facilitate the evaporation of accumulated water (“rainout”) periodically drained from the first and second storage tanks 20, 22 and absorbed into the first and second evaporation pads 56, 58 of the evaporation pad assembly 50 by operation of the first and second transfer solenoid valves 42, 44. This dual-purpose functionality, coupled with the with the positioning of the compressor 12 and the evaporation pad assembly 50 next to each other and between the first and second storage tanks 20, 22 and the cooling fan 14, further minimizes spatial requirements, thereby achieving spatial economies which promote making the PGS 10 as small and lightweight as possible.

In the PGS 10, the bleed assemblies of the first and second storage tanks 20, 22, the manifold 32, the first and second transfer tubes 46, 48, the first and second transfer solenoid valves 42, 44, and the evaporation pad assembly 50 collectively define the moisture evaporation system of the present disclosure. As explained above, this moisture evaporation system is operative to remove condensate from within the first and second storage tanks 20, 22 of the PGS 10 which is also outfitted with the compressor 12 and the cooling fan 14. In that moisture evaporation system, the periodic actuation of the first and second transfer solenoid valves 42, 44 to an open position is operative to selectively establish an open path of fluid communication between the first and second evaporation pads 56, 58 of the evaporation pad assembly 50 and respective ones of the first and second storage tanks 20, 22 via the bleed assemblies, manifold 32, first and second transfer tubes 46, 48, and outlet port 54 of the feed ring 52. In this regard, as also explained above, the actuation of the first and second transfer solenoid valves 42, 44 to the open position causes compressed gas in respective ones of the first and second storage tanks 20, 22 to force condensate therein though the open path of fluid communication corresponding thereto and into the evaporation pad assembly 50. The activation of the cooling fan 14 circulates air over both the compressor 12 and the evaporation pad assembly 50 to cool the compressor 12 and simultaneously facilitate moisture evaporation from the first and second evaporation pads 56, 58.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A portable gas source (PGS) comprising:
a housing;
a compressor disposed within the housing;
a cooling fan disposed within the housing;
at least one storage tank disposed within the housing and in fluid communication with the compressor for storing compressed gas;
at least one valve disposed within the housing and fluidly connected to the storage tank, the valve being selectively movable between a closed position and an open position; and
an evaporation pad assembly disposed within the housing and placeable into fluid communication with the storage tank when the valve is actuated to the open position, the evaporation pad assembly comprising:
a feed ring defining an outlet port which is fluidly connected to the valve such than an open path of fluid communication between the outlet port and the storage tank is established when the valve is actuated to the open position; and
at least one evaporation pad which is at least partially surrounded by the feed ring and positioned relative thereto to operatively absorb fluid flowing from the outlet port;
the compressor, the cooling fan, and the evaporation pad assembly being positioned within the housing relative to each other such that air circulated by the cooling fan passes over both the compressor and the evaporation pad assembly to cool the compressor and simultaneously facilitate moisture evaporation from the evaporation pad.

2. The PGS of claim 1 wherein:
the at least one storage tank comprises a first storage and a second storage tank which are fluidly connected to each other; and
the at least one valve comprises a first valve fluidly connected to the first storage tank and a second valve fluidly connected to the second storage tank;
the outlet port of the feed ring being fluidly connected to each of the first and second valves such that the first and second valves are operative to selectively establish an open path of fluid communication between the outlet port and respective ones of the first and second storage tanks when actuated to the open position.

3. The PGS of claim 2 wherein the first and second storage tanks are fluidly coupled to a common manifold which is configured to facilitate the fluid connection of the first and second storage tanks to each other and to respective ones of the first and second valves.

4. The PGS of claim 3 further comprising:
a first transfer tube which is fluidly connected to and extends between the first valve and the manifold to partially define the open path of fluid communication between the outlet port and the first storage tank when the first valve is in the open position; and
a second transfer tube which is fluidly connected to and extends between the second valve and the manifold to partially define the open path of fluid communication between the outlet port and the second storage tank when the second valve is in the open position.

5. The PGS of claim 4 wherein the first and second storage tanks are fluidly coupled to the manifold in side-by-side relation to each other, with the compressor and the evaporation pad assembly being positioned between the first and second storage tanks and the cooling fan.

6. The PGS of claim 5 wherein the compressor and the evaporation pad assembly are disposed in side-by-side relation to each other.

7. The PGS of claim 1 wherein:
the at least one evaporation pad comprises first and second evaporation pads which are each at least partially surrounded by the feed ring and are disposed in spaced relation to each other such that a gap is defined therebetween; and
the first and second evaporation pads are positioned relative to the feed ring such that the output port fluidly communicates with the gap in manner wherein fluid flowing from the outlet port may be absorbed by one or both of the first and second evaporation pads.

8. The PGS of claim 7 wherein the evaporation pad assembly further comprises first and second grate portions disposed in opposed, spaced relation to each other, the first and second evaporation pads and the feed ring being operatively captured between the first and second grate portions such that the first and second evaporation pads extend at least partially along and in contact with respective ones of the first and second grate portions.

9. The PGS of claim 8 wherein the first and second evaporation pads each have a circular, disc-like configuration and are coaxially aligned with each other between the first and second grate portions.

10. The PGS of claim 9 wherein the cooling fan is positioned relative to evaporation pad assembly such that air circulated by the cooling fan passes predominantly diametrically over respective surfaces of each of the first and second evaporation pads which do not face the gap therebetween.

11. The PGS of claim 1 wherein the evaporation pad assembly further comprises at least one grate portion, the at least one evaporation pad extending at least partially along and in contact with the grate portion.

12. The PGS of claim 10 wherein the evaporation pad has a circular, disc-like configuration, the grate portion has a circular configuration, and the evaporation pad and the grate portion are coaxially aligned with each other.

13. The PGS of claim 12 wherein the cooling fan is positioned relative to evaporation pad assembly such that air circulated by the cooling fan passes predominantly diametrically over a surface of the evaporation pad which faces the grate portion.

14. A portable gas source (PGS) comprising:
a compressor;
a cooling fan;
at least one storage tank in fluid communication with the compressor for storing compressed gas;
at least one valve disposed fluidly connected to the storage tank, the valve being selectively movable between a closed position and an open position;
a feed ring defining an outlet port which is fluidly connected to the valve such than an open path of fluid communication between the outlet port and the storage tank is established when the valve is actuated to the open position; and
at least one evaporation pad which is at least partially surrounded by the feed ring and positioned relative thereto to operatively absorb fluid flowing from the outlet port;
the compressor, the cooling fan, and the evaporation pad being positioned relative to each other such that air circulated by the cooling fan passes over both the compressor and the evaporation pad to cool the compressor and simultaneously facilitate moisture evaporation from the evaporation pad.

15. The PGS of claim 14 wherein:
the at least one storage tank comprises a first storage and a second storage tank which are fluidly connected to each; and
the at least one valve comprises a first valve fluidly connected to the first storage tank and a second valve fluidly connected to the second storage tank;
the outlet port of the feed ring being fluidly connected to each of the first and second valves such that the first and second valves are operative to selectively establish an open path of fluid communication between the outlet port and respective ones of the first and second storage tanks when actuated to the open position.

16. The PGS of claim 14 wherein:
the at least one evaporation pad comprises first and second evaporation pads which are each at least partially surrounded by the feed ring and are disposed in spaced relation to each other such that a gap is defined therebetween; and
the first and second evaporation pads are positioned relative to the feed ring such that the output port fluidly communicates with the gap in manner wherein fluidly flowing from the outlet port may be absorbed by one or both of the first and second evaporation pads.

17. The PGS of claim 16 wherein the first and second evaporation pads each have a circular, disc-like configuration and are coaxially aligned with each other.

18. The PGS of claim 17 wherein the cooling fan is positioned relative to the first and second evaporation pads such that air circulated by the cooling fan passes predominantly diametrically over respective surfaces of each of the first and second evaporation pads which do not face the gap therebetween.

19. In portable gas source (PGS) having a compressor, a cooling fan, and at least one storage tank in fluid communication with the compressor for storing compressed gas, a method for removing condensate from within the storage tank, comprising the steps of:
a). providing at least one valve which is fluidly connected to the storage tank and selectively movable between a closed position and an open position;
b.) providing a feed ring which defines an outlet port fluidly connected to the valve such than an open path of fluid communication between the outlet port and the storage tank is established when the valve is actuated to the open position;
c.) providing at least one evaporation pad which is cooperatively engaged to the feed ring to operatively absorb fluid flowing from the outlet port;
d.) actuating the valve to the open position to cause compressed gas in the storage tank to force condensate therein though the open path of fluid communication into the evaporation pad; and
e.) activating the cooling fan to circulate air over both the compressor and the evaporation pad to cool the compressor and simultaneously facilitate moisture evaporation from the evaporation pad.

20. The method claim 19 wherein the PGS comprises a first storage and a second storage tank which are fluidly connected to each other, and:
step (a) comprises providing a first valve which is fluidly connected to the first storage tank and a second valve which is fluidly connected to the second storage tank;
step (b) comprises fluidly connecting the outlet port to each of the first and second valves such that the first and second valves are operative to selectively establish an open path of fluid communication between the outlet port and respective ones of the first and second storage tanks when actuated to the open position; and
step (d) comprises alternately actuating the first and second valves to the open position to cause compressed gas in respective ones of the first and second storage tanks to force condensate therein though the open path of fluid communication corresponding thereto into the evaporation pad.
